(19) United States
(12) Patent Application Publication
(10) Pub. No.: US 2016/0230063 A1
(43) Pub. Date: Aug. 11, 2016

(54) BIONIC SHALE INHIBITOR AND PREPARATION METHOD THEREOF AND DRILLING FLUID

(71) Applicant: China University of Petroleum (Beijing), Beijing - Changping District (CN)

(72) Inventors: Guancheng Jiang, Beijing (CN); Yang Xuan, Beijing (CN); Xianzhu Wu, Beijing (CN); Ranran Song, Beijing (CN); Junbin Chen, Beijing (CN); Xi Wang, Beijing (CN); Wei Ouyang, Beijing (CN); Taotao Luo, Beijing (CN); Lan Wang, Beijing (CN)

(73) Assignee: China University of Petroleum (Beijing), Beijing - Changping District (CN)

(21) Appl. No.: 14/878,649

(22) Filed: Oct. 8, 2015

(30) Foreign Application Priority Data
Feb. 6, 2015 (CN) 201510064987.8

(51) Int. Cl. C09K 8/035; C09K 8/52

(52) U.S. Cl. CPC C09K 8/035; C09K 8/52; C09K 2208/12

(57) ABSTRACT

The present invention discloses a bionic shale inhibitor, consisting of structural units denoted by formula (1) and structural units denoted by formula (2), wherein, the molar ratio of the structural units denoted by formula (1) to the structural units denoted by formula (2) is 0.2-6:1, and the weight-average molecular weight of the shale inhibitor is 800-4,000 g/mol. The present invention further provides a method for preparation of a bionic shale inhibitor. The present invention further provides a drilling fluid containing the bionic shale inhibitor. The bionic shale inhibitor disclosed in the present invention has high shale inhibition capability, and is environment-friendly and pollution-free.

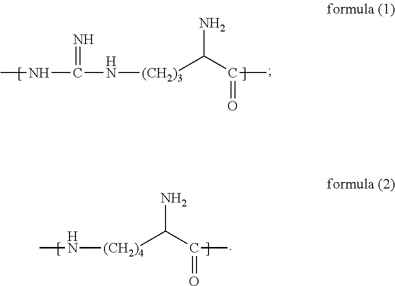

### CROSS REFERENCE TO RELATED APPLICATIONS

This application claims priority to Chinese Patent Application No. 201510064987.8 filed on Feb. 6, 2015 and entitled “BIONIC SHALE INHIBITOR AND PREPARATION METHOD THEREOF, AND DRILLING FLUID AND USE THEREOF”, the entire content of which is fully incorporated here by reference.

### FIELD OF THE INVENTION

The present subject matter relates to a bionic shale inhibitor, a method for preparation of the shale inhibitor and a drilling fluid.

### BACKGROUND OF THE INVENTION

Maintaining the stability of well walls of bored walls is a world-wide problem in the well drilling industry, and that problem exists in many oil fields in the world, and has not been solved well up to now. As the target of oil and gas exploration and development in China is further turned to unconventional resources such as deep-seated oil and gas resources, coal-seam gas reservoirs, and shale gas reservoirs under complex geological conditions, the well wall stability problem is often encountered in the exploration and drilling process, resulting in lower drilling speed in complex deep wells and horizontal shale gas wells, increased accidents, longer drilling cycle, and higher cost. That problem has severely affected the exploration and development process in important oil and gas resource replacement regions in China. Especially, in the oil and gas fields in the western regions in China (e.g., in Sichuan and Chongqing area), the geological conditions are extremely complex, and complex accidents, such as well wall collapse, well leakage, diameter shrinkage, jamming of drilling tools, logging blocking, and low cementing quality, etc., may occur easily at locations where the formation is high and steep, the strata are fractured, or the well traverses clay shale sections at a great deviation angle or horizontally. Consequently, not only the drilling cycle may be delayed, but also severe economic loss may occur.

90% borehole wall instability accidents in the well drilling process happen in the clay shale formation, where the dispersion and flaking-off of clay shale resulted from hydrated swelling of clay in the clay shale is the root cause for well wall instability. In the past few decades, oil-based drilling fluids always were an ideal choice for solving the problem of clay shale instability in well walls, owing to the fact that oil would not cause clay swelling. However, as the national environmental laws become strict increasingly, the application of oil-based drilling fluids is restricted owing to the severe damages of oil-based drilling fluids to the environment. Hence, water-based drilling fluids with strong shale inhibition capability have become a hot spot in the research again.

The shale inhibition capability of a water-based drilling fluid usually depends on the performance of the shale inhibitor in it. Since neutralizing the negative charges on the clay surface is the main approach for inhibiting hydrated dispersion, the shale inhibitors in almost all water-based drilling fluids commonly used in China and foreign countries presently are mainly cationic polymers, including cationic polyacrylamides, polyamines (e.g., poly-dimethyl diallyl ammonium chloride), and polyether amines (e.g., polyether diamine), etc.. However, most cationic polymer inhibitors are usually non-biodegradable and have more or less damages to the environment, except polyether amine inhibitors. But polyether amine inhibitors have positive charges in low density. Therefore, they have very limited inhibition capability against hydrated swelling of clay.

### SUMMARY OF THE INVENTION

To overcome the drawbacks of unsatisfactory shale inhibitor performance and environmental hazard in existing drilling fluids in the prior art, the present subject matter provides a bionic shale inhibitor that has high shale inhibition capability and is environment-friendly, a method for preparation of the bionic shale inhibitor and a bionic shale inhibitor containing the bionic shale inhibitor.

To that end, the present subject matter provides a bionic shale inhibitor, consisting of structural units denoted by formula (1) and structural units denoted by formula (2),

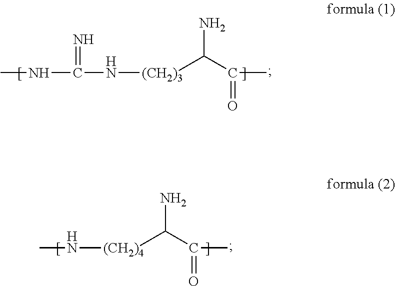

wherein, molar ratio of the structural units denoted by formula (1) to the structural units denoted by formula (2) is 0.2-6:1, and weight-average molecular weight of the bionic shale inhibitor is 800-4,000 g/mol.

The present subject matter further provides a preparation method of a bionic shale inhibitor, comprising: condensing arginine and lysine in the presence of an inorganic acid catalyst, wherein molar ratio of arginine to lysine is 0.2-6:1, conditions of the condensation reaction ensures weight-average molecular weight of the obtained polymer is 800-4,000 g/mol.

The present subject matter further provides a drilling fluid containing the above-mentioned bionic shale inhibitor.

The present subject matter utilizes a type of polyamino acid that is composed of structural units of arginine and lysine at a specific molar ratio and has weight-average molecular weight within a specific range as a bionic shale inhibitor, so that the bionic shale inhibitor can take an effective shale instability inhibition effect when it is used in a drilling fluid for maintaining the stability of shale well walls, and is easy to biodegrade and is environment friendly. Thus, the inhibitor can be referred to as a “bionic shale inhibitor”. In addition, the bionic shale inhibitor disclosed in the present subject matter has positive charges in high density, and can enter into the nanometer-level pores in clay shale and attach to the surfaces of clay minerals. Therefore, the bionic shale inhibitor can effectively compress the surface electric double layer of clay, reduce clay swelling pressure, and prevent well wall instability incurred by clay swelling.

Other aspects and advantages of the present subject matter will be further detailed in the embodiments hereunder.

### DETAILED DESCRIPTION

Hereunder some embodiments of the present subject matter will be detailed. It should be appreciated that the embodiments described here are only provided to describe and explain the present subject matter, but shall not be deemed as constituting any limitation to the present subject matter.

The present subject matter provides a bionic shale inhibitor, consisting of structural units denoted by formula (1) and structural units denoted by formula (2),

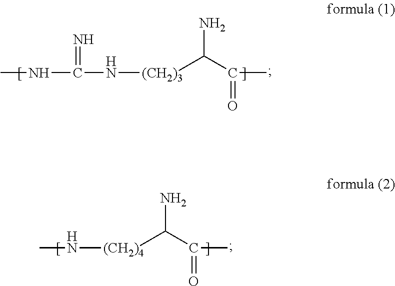

wherein, the molar ratio of the structural units denoted by formula (1) to the structural units denoted by formula (2) is 0.2-6:1, and the weight-average molecular weight of the bionic shale inhibitor is 800-4,000 g/mol.

In the present subject matter, the weight-average molecular weight of the bionic shale inhibitor is 800-4,000 g/mol, preferably is 1,550-4,000 g/mol, more preferably is 1,600-3,300 g/mol. By confining the weight-average molecular weight of the bionic shale inhibitor disclosed in the present subject matter within the above-mentioned range, the bionic shale inhibitor can effectively diffuse into pores in mean pore size within 4-10 nm range in shale strata at 2,000 m or greater burial depth, and the shale inhibitor has high adsorptive capacity and adsorptive strength on the surface of clay shale. In contrast, if the weight-average molecular weight of the bionic shale inhibitor is higher than 4,000 g/mol, it will be difficult for the bionic shale inhibitor to diffuse into the pores in mean pore size within 4-10 nm range in shale strata at 2,000 m or greater burial depth. If the weight-average molecular weight of the bionic shale inhibitor is lower than 800 g/mol, the bionic shale inhibitor will not have enough adsorptive strength on the surface of clay shale. In the present subject matter, the weight-average molecular weight is measured with the method described in the following examples.

According to the present subject matter, the structural units denoted by formula (1)

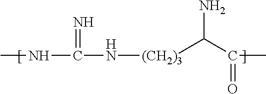

have a main chemical structure of arginine, and the structural units denoted by formula (2)

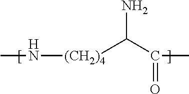

have a main chemical structure of lysine. Hence, actually, the bionic shale inhibitor disclosed in the present subject matter is a type of binary polyamino acid (i.e., condensed peptide of arginine and lysine). In the present subject matter, the structural units denoted by formula (1) and the structural units denoted by formula (2) are selected to constitute the bionic shale inhibitor disclosed in the present subject matter, because: on one hand, the structural units denoted by formula (1) and the structural units denoted by formula (2) are in amino acid structure and easy to be degraded by microbes; therefore, they can be defined as a “bionic shale inhibitor”; on the other hand, the structural unit denoted by formula (1) has three sites (e.g.,

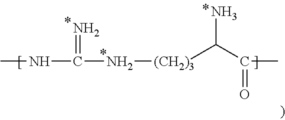

where cationic nitrogen can be formed, and the structural unit denoted by formula (2) has one site (e.g.,

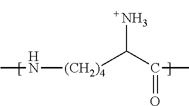

) where cationic nitrogen can be formed; hence, by combining the structural units denoted by formula (1) with the structural units denoted by formula (2), the bionic shale inhibitor disclosed in the present subject matter, which has an appropriate quantity of cations and superior shale inhibition capability, can be formed. There is no particular restriction on the terminal groups of the polymer constituted by the structural units denoted by formula (1) and the structural units denoted by formula (2) in the present subject matter. In other words, the terminal groups can be ordinary groups, such as H, hydroxy, or salts, etc..

According to the present subject matter, though it is only required that the bionic shale inhibitor should have weight-average molecular weight within 800-4,000 g/mol range and should be composed of the structural units denoted by formula (1) and the structural units denoted by formula (2) at a specific molar ratio range, the molar ratio of the structural units denoted by formula (1) to the structural units denoted by formula (2) preferably is 0.3-5:1, more preferably is 1-5:1, still more preferably is 1-4:1, even more preferably is 2-4:1, in order to ensure that the bionic shale inhibitor has better shale inhibition capability and can be more easily degraded by microbes subsequently. In a bionic shale inhibitor composed of the structural units denoted by formula (1) and the structural units denoted by formula (2) at the preferred molar ratio, the structural units denoted by formula (1) and the structural units denoted by formula (2) can work more synergistically to improve the shale inhibition capability and biodegradability of the bionic shale inhibitor, and the cost of the bionic shale inhibitor is relatively low.

There is no particular restriction on the structure of the binary polyamino acid. In other words, the binary polyamino acid can be a regular block copolymer, partially regular block copolymer, or random copolymer. To avoid introducing complexities into the production process, the bionic shale inhibitor disclosed in the present subject matter preferably is a random copolymer.

The present subject matter further provides a method preparation of a bionic shale inhibitor, comprising: condensing arginine and lysine in the presence of an inorganic acid catalyst, wherein molar ratio of arginine to lysine is 0.2-6:1, conditions of the condensation reaction ensures weight-average molecular weight of the obtained polymer is 800-4,000 g/mol.

According to the present subject matter, the arginine can be of L-type, D-type, or a mixture of the two types; the lysine can be of L-type, D-type, or a mixture of the two types. Preferably L-arginine and L-lysine are used.

According to the present subject matter, there is no particular restriction on the concentration of the arginine and the lysine, as long as the product of the condensation reaction has a weight-average molecular weight of 800-4,000 g/mol. In another embodiment, the molar ratio of arginine to lysine is 0.3-0.5:1, more preferably is 1-5:1, still more preferably is 1-4:1, even more preferably is 2-4:1.

According to the present subject matter, the condensation reaction proceeds in the presence of an inorganic acid catalyst. In the present subject matter, utilizing an inorganic acid catalyst rather than a basic compound has two purposes: one purpose is to promote the condensation reaction between the arginine and the lysine, so as to obtain the bionic shale inhibitor disclosed in the present subject matter at a higher yield ratio, while avoiding too high molecular weight of the polymer obtained through the condensation reaction; the other purpose is to enable the obtained polymer to bear cationic nitrogen at a higher level, so as to provide cations to the bionic shale inhibitor. The inorganic acid can be at 1-6 mol/L concentration. For example, the inorganic acid can be one or more of sulfuric acid, nitric acid, phosphoric acid and hydrochloric acid, preferably is phosphoric acid (e.g., 85-98 wt. % concentrated phosphoric acid). When phosphoric acid is used, the bionic shale inhibitor disclosed in the present subject matter can be obtained at a higher yield ratio.

According to another embodiment of the present subject matter, the molar ratio of the amount of the inorganic acid catalyst to the total amount of arginine and lysine is 1:0.3-3, more preferably is 1:0.4-3.

In a particularly embodiment of the present subject matter, the inorganic acid catalyst is phosphoric acid, and the molar ratio of the amount of the phosphoric acid to the total amount of arginine and lysine is 1:2-3. Thus, a bionic shale inhibitor with more appropriate weight-average molecular weight can be obtained.

According to the present subject matter, there is no particular restriction on the conditions of the condensation reaction, as long as the bionic shale inhibitor with 800-4,000 g/mol weight-average molecular weight can be prepared from the arginine and the lysine at the specified molar ratio. In other words, ordinary conditions for synthesis of an amino acid polymer in the art can be used, for example, a condensation reaction between arginine and lysine happened in a melted state of arginine and lysine. In another embodiment, the conditions of the condensation reaction include: 1 temperature is 180-230° C., time is 4-16 h. In another embodiment, the conditions of the condensation reaction include: temperature is 195-215° C., time is 8-16 h.

According to the present subject matter, the method disclosed in the present subject matter may further comprise: adjusting the pH of the mixture obtained through the condensation reaction to 6-7 after the condensation reaction is completed. In such a case, any basic compound can be used to adjust the pH, such as one or more of alkali metal hydroxides (e.g., sodium hydroxide, potassium hydroxide, or lithium hydroxide), alkali oxides (e.g., sodium oxide, potassium oxide, or lithium oxide), alkali carbonates (e.g., sodium carbonate, potassium carbonate, or lithium carbonate), alkali bicarbonates (e.g., sodium bicarbonate or potassium bicarbonate), and the basic compound can be in solution form or solid form (e.g., powder form or granular form, such as sodium hydroxide powder). In another embodiment, the basic compound can be in solution form; in another embodiment, the concentration of the basic compound solution is 1-10 mol/L. In another embodiment, the basic compound solution is a 3-5 mol/L sodium hydroxide aqueous solution, 3-5 mol/L potassium hydroxide aqueous solution, or saturated sodium carbonate aqueous solution. According to the present subject matter, to obtain the polymer through the condensation reaction, the method may further comprise: concentrating the solution after pH adjustment, drying, and grinding the obtained solid.

According to another embodiment of the present subject matter, the method further comprises: steps of adding water to dissolve the product when the temperature drops to 125° C. or a lower temperature after the reaction is completed, separating the obtained water solution and drying to obtain a solid product, and then dissolving the obtained solid product in dimethyl sulfoxide, and evaporating the obtained liquid, so as to obtain the bionic shale inhibitor disclosed in the present subject matter.

The present subject matter further provides a bionic shale inhibitor prepared with the method.

According to the present subject matter, the bionic shale inhibitor prepared with the method described above is a mixture of arginine-lysine copolymer, but the weight-average molecular weight of the arginine-lysine copolymer is within 800-4,000 g/mol range. In another embodiment, in the mixture of arginine-lysine copolymer, the molecular weight distribution coefficient Mw/Mn is 1.5-3.

The present subject matter further provides a drilling fluid containing the above-mentioned bionic shale inhibitor or a bionic shale inhibitor prepared with the above-mentioned method for preparation of a bionic shale inhibitor.

According to the present subject matter, the bionic shale inhibitor enables the drilling fluid to greatly improve well wall stability when the drilling fluid is used in well drilling. In another embodiment, the content amount of the bionic shale inhibitor is 1-5 wt. %, more preferably is 1-3 wt. %.

There is no particular restriction on the drilling fluid system that contains the bionic shale inhibitor in the present subject matter. In other words, the drilling fluid system can be any conventional drilling fluid system in the art, as long as the bionic shale inhibitor according to the present subject matter is added into the conventional drilling fluid system. As such a conventional drilling fluid system, for example, the drilling fluid can be one or more of potassium chloride-poly alcohol drilling fluid, silicone drilling fluid, and cationic drilling fluid. The potassium chloride-poly alcohol drilling fluid can be any potassium chloride-poly alcohol drilling fluid well known to those skilled in the art. For example, it can be one or more of potassium chloride-polyethyl glycol drilling fluid, potassium chloride-polypropyl glycol drilling fluid, potassium chloride-ethyl glycol/propyl glycol copolymer drilling fluid, potassium chloride-polyglycerol drilling fluid and potassium chloride-polyvinyl glycol drilling fluid. the organosilicon drilling fluid can be any organosilicon drilling fluid well known to those skilled in the art, and the organosilicon in the organosilicon drilling fluid can be selected from one or more of sodium methylsiliconate, potassium methylsiliconate, and silicone-potanssium humate. The cationic drilling fluid can be any cationic drilling fluid well known to those skilled in the art; for example, the cations in the cationic drilling fluid can be selected from one or more of 2,3-epoxypropyl trimethyl ammonium chloride, 3-chloro-2-hydroxypropyl trimethyl ammonium chloride, and cationic polyacrylamide.

According to the present subject matter, the drilling fluid preferably is a water-based drilling fluid, e.g., a multi-phase dispersed system in which water is the base substrate and a variety of additives are added. Furthermore, the drilling fluid disclosed in the present subject matter preferably is a cationic drilling fluid, and the cations in the cationic drilling fluid are provided only by the bionic shale inhibitor disclosed in the present subject matter (rather than provided by 2,3-epoxypropyltrimethyl ammonium chloride, 3-chloro-2-hydroxypropyltrimethylammonium chloride, or cationic polyacrylamide, etc.).

The cationic drilling fluid in which the cations are provided by the bionic shale inhibitor disclosed in the present subject matter can contain other additives for cationic drilling fluid. In another embodiment, the drilling fluid disclosed in the present subject matter contains one or more of bentonite, tackifier, anti-collapse agent, filtrate reducer, lubricant, potassium chloride, calcium carbonate, barium sulfate, and alkali hydroxide.

Wherein, the bentonite refers to clay which contains montmorillonite as the main mineral component and can endow the drilling fluid with viscous shearing force and filtration and wall building properties. For example, the bentonite can be sodium bentonite and/or calcium bentonite, preferably sodium bentonite. In another embodiment, the content amount of the bentonite is 2-4 wt. %, more preferably 3-4 wt. %.

Wherein, the tackifier can improve the viscous shearing force of the drilling fluid. For example, the tackifier can be one or more of potassium polyacrylamide (KPAM), polyanionic cellulose (e.g., PAC141), and copolymer of acrylamide and sodium acrylate (e.g., 80A51), preferably is potassium polyacrylamide. In another embodiment, the content amount of the tackifier is 0.2-0.5 wt. %, further more preferably is 0.3-0.5 wt. %.

Wherein, the anti-collapse agent can assist the bionic shale inhibitor to prevent collapse of the well wall and improve the stability of the well wall. For example, the anti-collapse agent can be one or more of potassium humate (KHM), silicone (e.g., GF-1), and sulfonated bitumen (e.g., FT-1A), preferably is potassium humate. In another embodiment, the content amount of the anti-collapse agent is 2-4 wt. %.

Wherein, the filtrate reducer can improve the filtration and wall building properties of the drilling fluid. For example, the filtrate reducer can be one or more of sulfomethylated phenolic resin (e.g., SMP-1, SMP-II), sulfomethylated lignite resin (e.g., SPNH), and zwitterionic polymer JT-888, preferably is SMP-II and/or SPNH. In another embodiment, the content amount of the filtrate reducer 1-8 wt. %, more preferably is 2-6 wt. %.

Wherein, the lubricant can improve the lubricating property of the drilling fluid and prevent complex downhole accidents such as jamming of a drilling tool. For example, the lubricant can be one or more of sulfonated oil sediment (e.g., FK-10), mixture of diesel oil and surface active agent (e.g., FRH), and mixture of fatty glyceride and surface active agent (e.g., FK-1), preferably is FK-10. In another embodiment, the content amount of the lubricant is 2-4 wt. %.

The above additives can be commercially available products, or can be prepared with conventional methods in the art. They will not be further detailed hereunder.

In the drilling fluid disclosed in another embodiment of the present subject matter, the content amount of potassium chloride is 3-5 wt. %. In another embodiment, the content amount of calcium carbonate is 3-5 wt. %. In another embodiment, the content amount of barite is 10-20 wt. % (e.g., barite with barium sulfate accounting for 90 wt. % or above content amount). In another embodiment, the content amount of the alkali hydroxide is 0.1-0.4 wt. %, more preferably is 0.1-0.2 wt. % (as a component of the drilling fluid, the alkali hydroxide can improve the mud-making performance of the bentonite, and can be one or more of sodium hydroxide, potassium hydroxide, and lithium hydroxide, and preferably is sodium hydroxide).

In an embodiment of the present subject matter, a drilling fluid is provided, containing 1-3 wt. % bionic shale inhibitor, 3-4 wt. % bentonite, 0.3-0.5 wt. % potassium polyacrylamide, 2-4 wt. % potassium humate, 2-4 wt. % SMP-II, 2-4 wt. % SPNH, 2-4 wt. % FK-10, 3-5 wt. % potassium chloride, 3-5 wt. % calcium carbonate, 10-20 wt. % barite, 0.1-0.2 wt. % sodium hydroxide, and water (rest content amount).

The present subject matter further provides a use of the drilling fluid in maintaining the stability of well wall of a shale well.

When the drilling fluid is used for maintaining the stability of well wall of a shale well, it can maintain the well wall in stable state by inhibiting the hydrated swelling of clay in the clay shale and decreasing the double electrode layer repulsion between adjacent clay grains in the pores of clay shale.

Hereunder the present subject matter will be further detailed in some embodiments.

In the following examples, the weight-average molecular weight is measured with a gel permeation chromatograph (GPC) (GPC Model E2695 from Waters Company (a USA company)); the molecular weight distribution coefficient is the ratio of the weight-average molecular weight to the number-average molecular weight measured with the GPC.

### EXAMPLE 1

This example is provided to describe the bionic shale inhibitor and the method for preparation of the bionic shale inhibitor in the present subject matter.

Stir and mix 0.5 mol (87.1 g) L-arginine and 0.2 mol (29.2 g) L-lysine at 195° C., add 1.75 mol (171.5 g) phosphoric acid (85 wt. % phosphoric acid aqueous solution), and hold for 16 h at 195° C. for reaction. Add 200 g water when the temperature drops to about 120° C. after the reaction is completed, and continue stirring for 20 min., so that the product is completely dissolved in water. Then, take out the reaction product (water solution) and dry it at about 120° C. to obtain a solid product, dissolve the solid product in dimethyl sulfoxide, and separate the insoluble substances from the solution by suction filtration. Next, evaporate the solution by rotary evaporation; thus, 91.8 g bionic shale inhibitor disclosed in the present subject matter is obtained. Measured by gel permeation chromatography, the weight-average molecular weight Mw is 1,551 g/mol, and the molecular weight distribution coefficient is 1.465. Analyzed by H-NMR spectroscopy and C-NMR spectroscopy, the molar ratio of the structural units denoted by formula (1) to the structural units denoted by formula (2) in the polymer is 2.47:1.

### EXAMPLE 2

This example is provided to describe the bionic shale inhibitor and the method for preparation of the bionic shale inhibitor in the present subject matter.

Stir and mix 0.8 mol (139.4 g) L-arginine and 0.2 mol (29.2 g) L-lysine at 200° C., add 0.35 mol (34.3 g) phosphoric acid (85 wt. % phosphoric acid aqueous solution), and hold for 8.5 h at 200° C. for reaction. Add 200 g water when the temperature drops to about 120° C. after the reaction is completed, and continue stirring for 20 min., so that the product is completely dissolved in water. Then, take out the reaction product (water solution) and dry it at about 120° C. to obtain a solid product, dissolve the solid product in dimethyl sulfoxide, and separate the insoluble substances from the solution by suction filtration. Next, evaporate the solution by rotary evaporation; thus, 145.8.8 g bionic shale inhibitor disclosed in the present subject matter is obtained. Measured by gel permeation chromatography, the weight-average molecular weight Mw is 3,248 g/mol, and the molecular weight distribution coefficient is 2.651. Analyzed by H-NMR spectroscopy and C-NMR spectroscopy, the molar ratio of the structural units denoted by formula (1) to the structural units denoted by formula (2) in the polymer is 3.96:1.

### EXAMPLE 3

This example is provided to describe the bionic shale inhibitor and the method for preparation of the bionic shale inhibitor in the present subject matter.

Stir and mix 0.8 mol (139.4 g) L-arginine and 0.3 mol (43.9 g) L-lysine at 215° C., add 0.45 mol (44.1 g) phosphoric acid (85 wt. % phosphoric acid aqueous solution), and hold for 9 h at 215° C. for reaction. Add 200 g water, and continue stirring for 20 min., so that the product is completely dissolved in water. Then, take out the reaction product (water solution) and dry it at about 120° C. to obtain a solid product, dissolve the solid product in dimethyl sulfoxide, and separate the insoluble substances from the solution by suction filtration. Next, evaporate the solution by rotary evaporation; thus, 158.4.8 g bionic shale inhibitor disclosed in the present subject matter is obtained. Measured by gel permeation chromatography, the weight-average molecular weight Mw is 2,480 g/mol, and the molecular weight distribution coefficient is 2.441. Analyzed by H-NMR spectroscopy and C-NMR spectroscopy, the molar ratio of the structural units denoted by formula (1) to the structural units denoted by formula (2) in the polymer is 2.55:1.

### EXAMPLE 4

This example is provided to describe the bionic shale inhibitor and the method for preparation of the bionic shale inhibitor in the present subject matter.

Stir and mix 0.15 mol (26.1 g) L-arginine and 0.5 mol (73.1 g) L-lysine at 210° C., add 1.5 mol (147 g) sulfuric acid (65 wt. % sulfuric acid aqueous solution), and hold for 12 h at 210° C. for reaction. Add 200 g water, and continue stirring for 20 min., so that the product is completely dissolved in water. Then, take out the reaction product (water solution) and dry it at about 120° C. to obtain a solid product, dissolve the solid product in dimethyl sulfoxide, and separate the insoluble substances from the solution by suction filtration. Next, evaporate the solution by rotary evaporation; thus, 84.3.8 g bionic shale inhibitor disclosed in the present subject matter is obtained. Measured by gel permeation chromatography, the weight-average molecular weight Mw is 1,950 g/mol, and the molecular weight distribution coefficient is 1.65. Analyzed by H-NMR spectroscopy and C-NMR spectroscopy, the molar ratio of the structural units denoted by formula (1) to the structural units denoted by formula (2) in the polymer is 0.32:1.

### EXAMPLE 5

This example is provided to describe the bionic shale inhibitor and the method for preparation of the bionic shale inhibitor in the present subject matter.

According to the method described in the example 1, but the difference is holding the reaction of L-arginine and L-lysine at 190° C. for 8 h. Thus, 100.5 g bionic shale inhibitor disclosed in the present subject matter is obtained. Measured by gel permeation chromatography, the weight-average molecular weight Mw is 845 g/mol, and the molecular weight distribution coefficient is 1.232. Analyzed by H-NMR spectroscopy and C-NMR spectroscopy, the molar ratio of the structural units denoted by formula (1) to the structural units denoted by formula (2) in the polymer is 2.5:1.

### COMPARATIVE EXAMPLE 1

According to the method described in the example 1, but the difference is adding more L-lysine of 0.5 mol to replace L-arginine; thus, 100.2 g poly-lysine shale inhibitor is obtained. Measured by gel permeation chromatography, the weight-average molecular weight Mw is 1,720 g/mol, and the molecular weight distribution coefficient is 1.45.

### COMPARATIVE EXAMPLE 2

Stir and mix 0.5 mol (87.1 g) L-arginine and 0.2 mol (29.2 g) L-lysine at 195° C., add 3 mol (294 g) phosphoric acid (85 wt. % phosphoric acid aqueous solution), and hold for 2 h at 195° C. for reaction. Add 200 g water when the temperature drops to about 120° C. after the reaction is completed, and continue stirring for 20 min., so that the product is completely dissolved in water. Then, take out the reaction product (water solution) and dry it at about 120° C. to obtain a solid product, dissolve the solid product in dimethyl sulfoxide, and separate the insoluble substances from the solution by suction filtration. Next, evaporate the solution by rotary evaporation; thus, 78.6 g shale inhibitor disclosed in the present subject matter is obtained. Measured by gel permeation chromatography, the weight-average molecular weight Mw is 553 g/mol, and the molecular weight distribution coefficient is 1.76. Analyzed by H-NMR spectroscopy and C-NMR spectroscopy, the molar ratio of the structural units denoted by formula (1) to the structural units denoted by formula (2) in the polymer is 2.61:1.

### COMPARATIVE EXAMPLE 3

Stir and mix 0.5 mol (87.1 g) L-arginine and 0.2 mol (29.2 g) L-lysine at 195° C., add 0.15 mol (14.7 g) phosphoric acid (85 wt. % phosphoric acid aqueous solution), and hold for 20 h at 195° C. for reaction. Add 200 g water when the temperature drops to about 120° C. after the reaction is completed, and continue stirring for 20 min., so that the product is completely dissolved in water. Then, take out the reaction product (water solution) and dry it at about 120° C. to obtain a solid product, dissolve the solid product in dimethyl sulfoxide, and separate the insoluble substances from the solution by suction filtration. Next, evaporate the solution by rotary evaporation; thus, 91.5 g shale inhibitor disclosed in the present subject matter is obtained. Measured by gel permeation chromatography, the weight-average molecular weight Mw is 5,273 g/mol, and the molecular weight distribution coefficient is 3.45. Analyzed by H-NMR spectroscopy and C-NMR spectroscopy, the molar ratio of the structural units denoted by formula (1) to the structural units denoted by formula (2) in the polymer is 2.41:1.

### APPLICATION EXAMPLES 1-5

Prepare water-based drilling fluids with the following formulation: 3 wt. % of sodium bentonite (from Shandong Weifang Huawei Bentonite Co., Ltd., China), 0.2 wt. % of NaOH, 0.5 wt. % of KPAM (HL/K-PAM from Jiangxi Pingxiang Wuhan Chemical Plant, China, the same below), 4 wt. % of KHM (from Jiangxi Pingxiang Boxin Industry Co., Ltd., China, the same below), 4 wt. % of SMP-II (from Jiangxi Pingxiang Hengchang New Chemical Materials Co., Ltd., China, the same below), 4 wt. % of FK-10 (from Hunan Zhongceng Technology Development Co., Ltd., China, the same below), 3 wt. % of potassium chloride, 3 wt. % of calcium carbonate, 10 wt. % of barite (with 93 wt. % barium sulfate content amount, from Shandong Lingshou Xingwang Minerals Processing Plant, China, the same below), 1 wt. % of bionic shale inhibitors prepared in the examples 1-5 respectively, and water (rest content amount); thus, drilling fluids A1-A5 are obtained respectively.

### APPLICATION EXAMPLE 6

Prepare a water-based drilling fluid with the following formulation: 3 wt. % of sodium bentonite, 0.2 wt. % of NaOH, 0.5 wt. % of KPAM, 4 wt. % of KHM, 4 wt. % of SMP-II, 2 wt. % of SPNH, 4 wt. % of FK-10, 3 wt. % of potassium chloride, 3 wt. % of calcium carbonate, 10 wt. % of barite, 3 wt. % of bionic shale inhibitor prepared in the example 1, and water (rest content amount); thus, a drilling fluid A6 is obtained.

### COMPARATIVE APPLICATION EXAMPLES 1-5

According to the formulation in the application embodiment 1, but the difference is adding 1 wt. % of shale inhibitors obtained in the comparative examples 1-3, 1 wt. % of ULTRAHIB (polyamine shale inhibitor from China Nanhai Maikeba Mud Co., Ltd. China) or 1 wt. % of 2,3-epoxypropyltrimethyl ammonium chloride (from Shandong Luyue Chemicals Co., Ltd. China) respectively instead of the bionic shale inhibitor prepared in the example 1; thus, drilling fluids DA1-DA5 are obtained.

### COMPARATIVE APPLICATION EXAMPLE 6

According to the formulation in the example 1, but the difference is adding more potassium chloride of 6 wt. % to replace the bionic shale inhibitor prepared in the example 1; thus, a drilling fluid DA6 is obtained.

### TEST EXAMPLE 1

Measure the BOD5 values of the shale inhibitors prepared in the examples 1-5 and comparative examples 1-3 as per GB/T 7488-87 “Water Quality; Determination of Biochemical Oxygen Demand after 5 Days (BOD5)”, measure the CODCr values of them as per GB/T 11914-89 (Water Quality; Determination of Chemical Oxygen Demand—Potassium Dichromate Method), and obtain BOD5/CODCr values through calculation. The results are shown in Table 1.

TABLE 1

| | | | BOD₅/ |
|---|---|---|---|
| Shale Inhibitor | BOD₅/mg · L⁻¹ | COD_{Cr}/mg · L⁻¹ | COD_{Cr} |
| Example 1 | 113 | 153 | 0.738 |
| Example 2 | 124 | 170 | 0.729 |
| Example 3 | 109 | 166 | 0.656 |
| Example 4 | 131 | 168 | 0.779 |
| Example 5 | 122 | 155 | 0.786 |
| Comparative example 1 | 107 | 144 | 0.743 |
| Comparative example 2 | 105 | 133 | 0.789 |
| Comparative example 3 | 104 | 151 | 0.691 |

### TEXT EXAMPLE 2

Measure the plastic viscosity, dynamic shearing force, API filter loss, HTHP filter loss, and hot rolling recovery rate of drilling fluids A1-A6 and DA1-DA6 with the methods defined in GB/T 16783.1-2006 “Petroleum and Natural Gas Industry—Field Testing of Drilling Fluids—Part 1: Water-Based Fluids”.

The hot rolling recovery rate measurement method includes: take 300 mL drilling fluids described above and load them into hot cans, add 50 g of 6-10 mesh clay shale cuttings into them, and carry out hot rolling for 16 h at 130° C., respectively; then, sieve them through a 40 mesh sieve, wash with tap water for about 2 min., and dry the screen tailings at 105±3° C. to constant weight respectively; next, weigh the obtained products, and calculate the hot rolling recovery rate R=weight after drying/dry weight before test. The higher the recovery rate is, the higher the inhibition capability of the treating agent is; in contrast, the lower the recovery rate is, the lower the inhibition capability of the treating agent is.

The test results are shown in Table 2.

TABLE 2

| | | Dynamic | | | |
|---|---|---|---|---|---|
| | | Shearing | | HTHP | Hot Rolling |
| | Plastic Viscosity/ | Force/ | API Filter | Filter | Recovery |
| | mPa · s | Pa | Loss/mL | loss/mL | Rate/% |
| A1 | 28 | 11.5 | 5.2 | 12.8 | 97.2 |
| A2 | 28 | 13.5 | 5.8 | 15.6 | 95.6 |
| A3 | 27 | 13 | 5.8 | 15.2 | 95.8 |
| A4 | 27 | 12 | 5.8 | 15.1 | 96.3 |
| A5 | 26 | 12.5 | 6.2 | 16.4 | 98.1 |
| A6 | 30 | 17.5 | 7.2 | 17.4 | 98.8 |
| DA1 | 29 | 9 | 4.8 | 12.6 | 89.5 |
| DA2 | 28 | 12 | 6 | 15.4 | 77.5 |
| DA3 | 32 | 14 | 5 | 12.6 | 81.5 |
| DA4 | 23 | 8.5 | 4 | 9.5 | 85.4 |
| DA5 | 25 | 11 | 5.2 | 14.4 | 78.2 |
| DA6 | 32 | 14.5 | 8.2 | 17.8 | 83.2 |

It can be seen from Table 1: actually all the polymers provided in the examples 1-5 and comparative examples 1-3 are polyamino acid inhibitors, and the BOD5/CODCr values of them are higher than 0.65, indicating that the polymers are of readily biodegradable substances. Hence, after these polymers are used in drilling fluids for protection of oil/gas reservoirs, they can be bio-degraded. Therefore, these polymers are high environment friendly, and will not cause long-term damages to the ecological environment.

It can be seen from Table 2: in the drilling fluids A1-A6, which contain the bionic shale inhibitor disclosed in the present subject matter, the plastic viscosity is 25-35 mPa·s, particularly preferably is 28-30 mPa·s; the dynamic shearing force is 10-20 Pa, particularly preferably is 11-18 Pa, indicating that these drilling fluids have favorable rheological property and cuttings carrying property; the API filter loss is 5-8 mL, particularly preferably is 5-6 mL; the HTHP filter loss is 12-18 mL, particularly preferably is 12-16 mL, indicating that these drilling fluids have favorable filtrate reducing and wall building properties; the hot rolling recovery rate is 95-99%, particularly preferably is 96-99%, indicating that these drilling fluids have outstanding clay shale dispersion inhibition capability and well wall stability maintaining capability. In contrast, the drilling fluids DA1-DA6, which don't utilize the shale inhibitor disclosed in the present subject matter, have specific drawbacks, wherein, drilling fluid DA1 has lower shale inhibition capability, as indicated by the parameter of hot rolling recovery rate; the drilling fluids DA2 and DA3, in which a polymer of tyrosine and arginine with weight-average molecular weight and molar ratio between structural units beyond the ranges disclosed in the present subject matter serves as a shale inhibitor respectively, have lower shale inhibition capability, as indicated by the parameter of hot rolling recovery rate; drilling fluids DA4, DA5 and DA6 have lower shale inhibition capability, as indicated by the parameter of hot rolling recovery rate, though they have favorable rheology property.

While some preferred embodiments of the present invention are described above, the present invention is not limited to the details in those embodiments. Those skilled in the art can make modifications and variations to the technical scheme of the present invention, without departing from the spirit of the present invention. However, all these modifications and variations shall be deemed as falling into the protected domain of the present invention.

In addition, it should be noted that the specific technical features described in above embodiments can be combined in any appropriate form, provided that there is no conflict. To avoid unnecessary repetition, the possible combinations are not described specifically in the present invention.

Moreover, different embodiments of the present invention can be combined freely as required, as long as the combinations don't deviate from the ideal and spirit of the present invention. However, such combinations shall also be deemed as falling into the scope disclosed in the present invention.

1. A bionic shale inhibitor, consisting of structural units denoted by formula (1) and structural units denoted by formula (2), 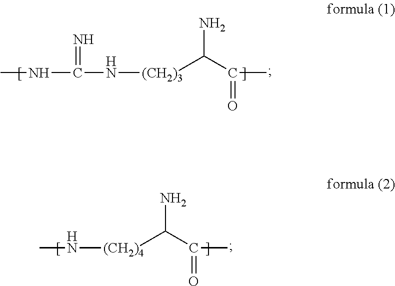
wherein a molar ratio of the structural units denoted by formula (1) to the structural units denoted by formula (2) is 2:1 to 6:1, and a weight-average molecular weight of the bionic shale inhibitor is 800-4,000 g/mol.

2. The bionic shale inhibitor according to claim 1 wherein the weight-average molecular weight of the bionic shale inhibitor is 1,550-4,000 g/mol.

3. The bionic shale inhibitor according to claim 1 wherein a molecular weight distribution coefficient of the bionic shale inhibitor is 1.5-3.

4. A method for the preparation of a bionic shale inhibitor, comprising: condensing arginine and lysine in the presence of an inorganic acid catalyst, wherein a molar ratio of arginine to lysine is 2:1 to 6:1, wherein the conditions of the condensation reaction ensures a weight-average molecular weight of the obtained polymer is 800-4,000 g/mol.

5. The method according to claim 4 wherein the molar ratio of arginine to lysine is 2:1 to 4:1.

6. The method according to claim 4 wherein the conditions of the condensation reaction comprise: a temperature of 180-230° C. and a time of 4-16 h.

7. The method according to claim 4 wherein a molar ratio of the inorganic acid catalyst to the total amount of the arginine and lysine is 1:3 to 1:0.3.

8. The method according to claim 7 wherein the inorganic acid catalyst is one or more of sulfuric acid, nitric acid, phosphoric acid, and hydrochloric acid.

9. The method according to claim 8 wherein the inorganic acid catalyst is phosphoric acid.

10. The method according to claim 4 further comprising: adjusting the pH of the mixture obtained from the condensation reaction to 6-7 after the condensation reaction is completed.

12. A drilling fluid, comprising the bionic shale inhibitor according to claim 1.

13. The drilling fluid according to claim 12 wherein the bionic shale inhibitor comprises 1-5 wt. % of the drilling fluid.

14. The drilling fluid according to claim 12 comprising the bionic shale inhibitor of claim 2.

15. The drilling fluid according to claim 12 comprising the bionic shale inhibitor of claim 3.

16. The drilling fluid according to claim 12 wherein the bionic shale inhibitor is prepared with the method of claim 4.

17. The drilling fluid according to claim 12 wherein the bionic shale inhibitor is prepared with the method of claim 5.

18. The drilling fluid according to claim 12 wherein the bionic shale inhibitor is prepared with the method of claim 6.

19. The drilling fluid according to claim 12 wherein the bionic shale inhibitor is prepared with the method of claim 7.

20. The drilling fluid according to claim 12 wherein the bionic shale inhibitor is prepared with the method of claim 8.

21. The bionic shale inhibitor according to claim 1 wherein the molar ratio of the structural units denoted by formula (1) to the structural units denoted by formula (2) is 2:1 to 4:1.
